(19) United States
(12) Patent Application Publication
(10) Pub. No.: US 2024/0396355 A1
(43) Pub. Date: Nov. 28, 2024

(54) CHARGING DEVICE

(71) Applicant: TOYOTA JIDOSHA KABUSHIKI KAISHA, Toyota-shi (JP)

(72) Inventors: Yoshinori AOKI, Toyota-shi (JP); Yoshiki TSUCHIDA, Toyota-shi (JP)

(73) Assignee: TOYOTA JIDOSHA KABUSHIKI KAISHA, Toyota-shi (JP)

(21) Appl. No.: 18/666,314

(22) Filed: May 16, 2024

(30) Foreign Application Priority Data
May 23, 2023 (JP) 2023-084417

(51) Int. Cl. H02J 7/00

(52) U.S. Cl. CPC H02J 7/007182; H02J 7/0049; H02J 7/0071; H02J 7/007192

(57) ABSTRACT

A control device of a charging device performs constant current charging, when starting charging at time t0. When the SOC of a battery reaches a set value α at time t1, the charging current is limited to gradually decrease. When the battery voltage VB of the battery reaches a charging completion voltage VBb at time t2, charging is terminated. When the charging current is small, the polarization is small, and therefore, the charging completion voltage VBb can be set to a value corresponding to the full state of charge, to charge the battery to a state close to the full state of charge without relying on CV charging.

### CROSS REFERENCE TO RELATED APPLICATIONS

This nonprovisional application is based on Japanese Patent Application No. 2023-084417 filed on May 23, 2023 with the Japan Patent Office, the entire contents of which are hereby incorporated by reference.

### BACKGROUND

### Field

The present disclosure relates to a charging device.

### Description of the Background Art

As a method of charging a rechargeable secondary battery (battery), CCCV (Constant Current Constant Voltage) charging is known. In CCCV charging, charging is performed with a constant current (CC charging), and when the battery voltage reaches a set voltage, charging is performed with a constant voltage (CV charging). As a result, the battery can be charged to a state close to the full state of charge, while avoiding the overvoltage state of the battery.

CCCV charging is a combination of CC charging and CV charging, and is therefore complicated, and in particular, there is a concern that the configuration and control of a charging device become complicated in order to maintain a constant voltage with high accuracy. In Japanese Patent Laying-Open No. 2022-176558, charging is performed so that a predetermined SOC (State Of Charge) is maintained, and when this continues for a predetermined time, refresh charging to a full state of charge is performed. As a result, a decrease in the SOC of the battery is suppressed.

Japanese Patent Laying-Open No. 2022-176558 aims to maintain the SOC of the battery in the vicinity of the full state of charge and does not consider charging of the battery discharged to a voltage in the vicinity of the discharge end.

### SUMMARY

An object of the present disclosure is to enable a battery to be charged to a state close to a full state of charge even when the charging device does not have the CV charging function.

A charging device according to the present disclosure is a charging device for charging a battery, and includes a control device. The control device is configured to perform charging with a predetermined current until a SOC of the battery reaches a set value, perform charging with a limited current value smaller than the predetermined current, when the SOC reaches the set value, and terminate charging when a voltage of the battery reaches a charging completion voltage.

According to this configuration, when the SOC of the battery reaches the set value, charging is thereafter performed with a limited current value smaller than the predetermined current, and when the voltage of the battery reaches the charging completion voltage, charging is ended. When the charging current is small, the polarization is small (because the overvoltage is small), and therefore, if the charging completion voltage is set to a value corresponding to the full state of charge, it is possible to charge the battery to a state close to the full state of charge without relying on CV charging.

Preferably, the limited current value may gradually decrease.

According to this configuration, since the limited current value gradually decreases, the polarization becomes smaller as the voltage of the battery approaches the charging completion voltage, so that charging can be performed to a state close to the full state of charge.

Preferably, the predetermined current may be a constant current value.

According to this configuration, since charging is performed with a constant current value, charging control can be performed relatively easily.

Preferably, the set value and the charging completion voltage may be set based on a temperature of the battery.

According to this configuration, even if the magnitude of the polarization or the battery capacity varies depending on the temperature of the battery, the set value and the charging completion voltage are set based on the temperature of the battery, and thus it is possible to charge the battery to a state close to the full state of charge.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an overall configuration diagram of a charging system according to the present embodiment.

FIG. 2 is a flowchart showing an example of charging control executed by a control device.

FIGS. 3A to 3C are diagrams illustrating the transition of the SOC during charging.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

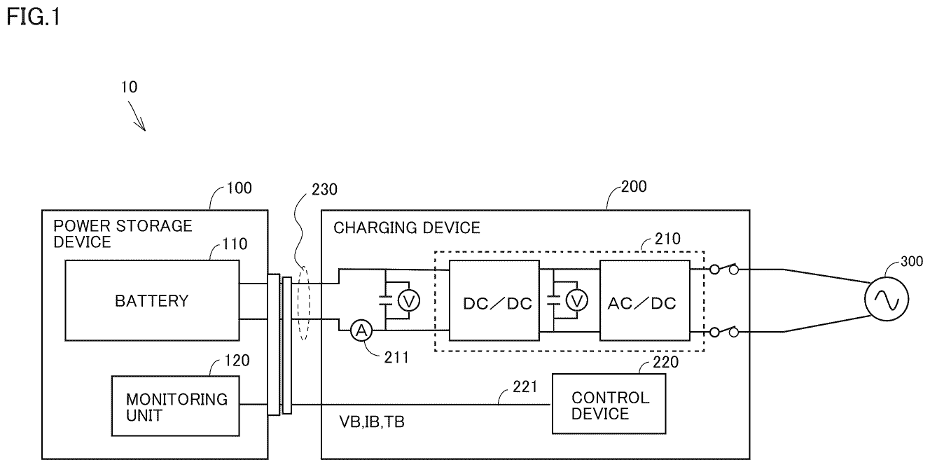

FIG. 1 is an overall configuration diagram of a charging system according to the present embodiment. In the present embodiment, charging system 10 charges power storage device 100 with electric power of external power supply 300 using charging device 200. Power storage device 100 includes a battery 110 and a monitoring unit 120. The battery 110 corresponds to one example of the “battery” of the present disclosure, and is, for example, a battery assembly configured from a lithium ion battery.

The monitoring unit 120 includes a voltage sensor, a current sensor, and a temperature sensor. The voltage sensor detects a voltage (battery voltage) VB of the battery 110. The current sensor detects a current IB input to and output from the battery 110. The temperature sensor detects the temperature of the battery 110. A detection signal of each sensor is input to a control device 220 described later.

The charging device 200 charges the battery 110 using power of an external power supply 300 (for example, a power system). The charging device 200 includes a charging circuit 210 and a control device 220. The charging circuit 210 includes, for example, an AC/DC converter that converts AC power of the external power supply 300 into DC power and a DC/DC converter that converts a voltage of the DC power. The AC/DC converter may be an inverter. The control device 220 controls a charging current supplied from the charging device 200 (charging circuit 210) to the battery 110. Current sensor 211 detects charging current CA supplied from charging device 200 to battery 110, and outputs the detected charging current CA to control device 220.

The control device 220 includes a CPU (Central Processing Unit) and a memory (ROM (Read Only Memory) and RAM (Random Access Memory)). The control device 220 controls charging of the battery 110 based on signals received from the monitoring unit 120, the current sensor 211, and the like. When the charging cable 230 of the charging device 200 is connected to the power storage device 100 (the battery 110) via the connector, charging of the power storage device 100 (the battery 110) from the charging device 200 (the charging circuit 210) is started. When the charging cable 230 is connected to the power storage device 100, communication is performed between the monitoring unit 120 and the control device 220 via the communication line 221. The communication between the monitoring unit 120 and the control device 220 may be wireless communication.

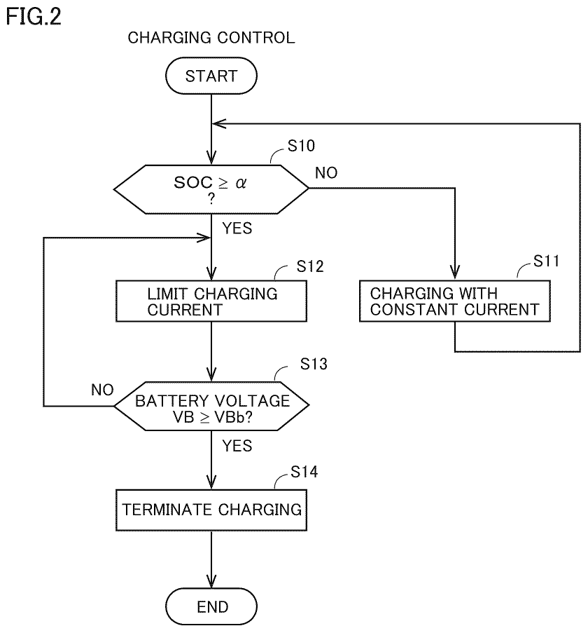

FIG. 2 is a flowchart illustrating an example of charging control executed by the control device 220. When the charging cable 230 is connected to the power storage device 100 via the connector and charging is started, the process of the flowchart is started. In step (hereinafter, abbreviated as “S”) 10, the control device 220 determines whether or not the SOC of the battery 110 is equal to or greater than a set value α. The SOC may be estimated from SOC-OCV (Open Circuit Voltage) characteristics, for example, or may be combined with a Coulomb counting method (current integration method). The SOC may be calculated by the control device 220 based on the detection signal of the monitoring unit 120. When the monitoring unit 120 has the function of BMS (Buttery Management System), the SOC may be calculated by the monitoring unit 120. The set value α may be 95%, for example.

When the SOC of the battery 110 is smaller than the set value α, a negative determination is made and the process proceeds to S11. In S11, the control device 220 controls the charging circuit 210 to perform constant current charging (CC charging), and the process returns to S10. The current in the constant current charging corresponds to the “predetermined current” of the present disclosure.

When charging of the battery 110 progresses and the SOC becomes equal to or higher than the set value α, an affirmative determination is made in S10, and the process proceeds to S12. In S12, the control device 220 controls the charging circuit 210 to limit the charging current. In the present embodiment, the charging circuit 210 is controlled so that the charging current gradually decreases (so that the charging current decreases with time), and the process proceeds to S13.

In S13, the control device 220 determines whether or not the battery voltage VB is equal to or higher than the charging completion voltage VBb. The charging completion voltage VBb may be, for example, a battery voltage corresponding to SOC=98%. When the battery voltage VB is smaller than the charging completion voltage VBb, a negative determination is made in S13 and the process returns to S12, and the control device 220 continues charging while gradually decreasing the charging current.

When the battery voltage VB becomes equal to or higher than the charging completion voltage VBb, an affirmative determination is made in S13, and the process proceeds to S14. In S14, the control device 220 ends the charging and ends the current routine.

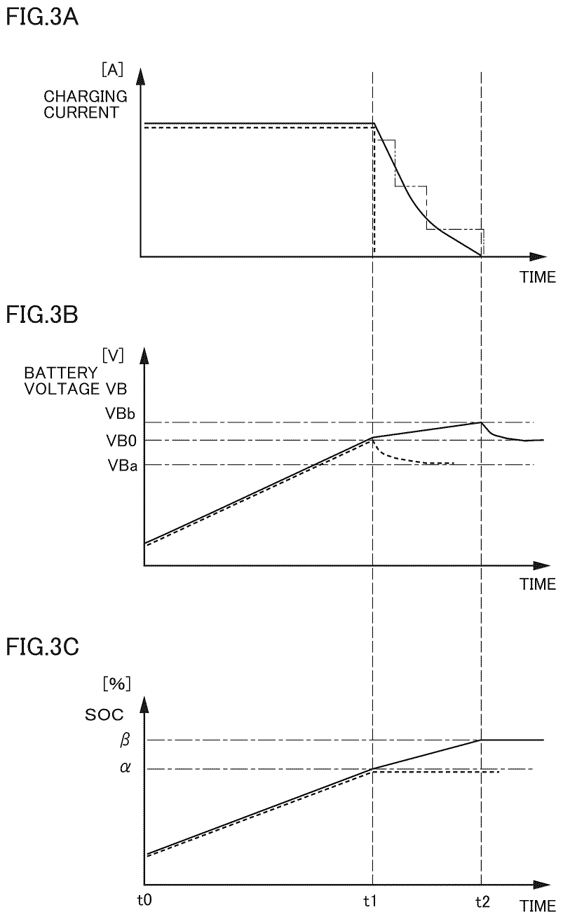

FIG. 3 is a diagram illustrating the transition of the SOC during charging. FIG. 3A shows the transition of the charging current, FIG. 3B shows the transition of the battery voltage VB, and FIG. 3C shows the transition of the SOC. In FIGS. 3A to 3C, a solid line indicates a transition during charging of the present embodiment, and a broken line indicates a transition during CC charging.

When charging is started at time t0 by CC charging, as indicated by a broken line in FIG. 3A, a constant current is supplied to the battery 110, and constant current charging is performed. When charging progresses and the battery voltage VB and SOC increase and the battery voltage VB reaches the charging completion voltage VB0 at time t1, charging ends (the charging current becomes 0). When the charging is completed, the polarization is resolved over time, and the battery voltage VB becomes VBa as indicated by the broken line in FIG. 3B. The SOC at the end of charging is a as indicated by the broken line in FIG. 3C. In CC charging, in order to reliably avoid overcharging, the charging completion voltage VB0 is set to a voltage lower than the charging completion voltage VBb in the present embodiment in consideration of the influence of polarization of the battery 110.

In the present embodiment (FIG. 2), when charging is started at time t0, as shown by the solid line in FIG. 3A, a constant current is supplied to the battery 110, and constant current charging is performed. When the SOC reaches the set value α, the charging current is limited and gradually decreases. The charging is continued by the limited current, and when the battery voltage VB reaches the charging completion voltage VBb at time t2, the charging is ended (the charging current becomes 0). The charging completion voltage VBb may be a value obtained by adding polarization to the OCV of the battery 110 at the charging completion voltage VB0 (corresponding to the target voltage in CC charging) in CC charging. When the charging is completed, the polarization is released with the lapse of time, and the battery voltage VB becomes VB0 as indicated by the solid line in FIG. 3B. When the charging current is small, the polarization becomes small (since the overvoltage becomes small), and thus the SOC at the end of the charging becomes β(<α) as shown by the solid line in FIG. 3C. When the charging completion voltage VBb is set to a value corresponding to the full state of charge, the battery can be charged to the vicinity of the full state of charge without relying on the CV charge. In the present embodiment, β is 98 to 100%.

According to the present embodiment, when charging of the battery 110 is started, charging is performed with a constant current (predetermined current), and when the SOC of the battery 110 reaches the set value α, charging is performed with a limited current value smaller than the predetermined current. When the battery voltage VB of the battery 110 reaches the charging completion voltage VBb, the charging is ended. When the charging current is small, the polarization becomes small (because the overvoltage becomes small), and therefore, if the charging completion voltage VBb is set to a value corresponding to the full state of charge, the battery can be charged to the vicinity of the full state of charge without depending on the CV charging. In addition, since CC charging (constant current charging) is performed until the SOC reaches the predetermined value α, and then the charging current is limited, it is not necessary to accurately manage the charging voltage, and the configuration and specification of the charging device 200 can be relatively simplified.

The set value α and the charging completion voltage VBb may be set based on the temperature TB of the battery 110. For example, since the polarization becomes smaller as the battery temperature TB becomes higher, the set value α may be set larger as the battery temperature TB becomes higher. Thus, the charging time until the full state of charge can be reduced. In addition, by setting the charging completion voltage VBb to be higher as the battery temperature TB is higher, it is possible to charge the battery to near the full state of charge while avoiding overcharge. Since deterioration of the battery 110 can be promoted when charging is performed when the temperature of the battery temperature TB is high, the charging completion voltage VBb may be set to be lower as the battery temperature TB is higher in order to avoid this.

In the above embodiment, the charging current is limited when the SOC of the battery 110 reaches the set value α. The charging current may be limited when the battery voltage VB becomes a battery voltage (for example, VB0) corresponding to SOC=α. This also provides the same function as limiting the charging current when the SOC reaches the set value α.

In the above embodiment, when the SOC of the battery 110 reaches the set value α, the charging current is gradually decreased. As indicated by a one-dot chain line in FIG. 3A, when the SOC reaches the set value α, the charging current may be decreased stepwise to limit the charging current.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A charging device for charging a battery, the charging device comprising a control device, wherein
the control device is configured to
perform charging with a predetermined current until a state of charge (SOC) of the battery reaches a set value,
perform charging with a limited current value smaller than the predetermined current, when the SOC reaches the set value, and
terminate charging when a voltage of the battery reaches a charging completion voltage.

2. The charging device according to claim 1, wherein the limited current value gradually decreases.

3. The charging device according to claim 1, wherein the predetermined current is a constant current value.

4. The charging device according to claim 1, wherein the set value and the charging completion voltage are set based on a temperature of the battery.
